(19) United States
(12) Patent Application Publication
(10) Pub. No.: US 2012/0121271 A1
(43) Pub. Date: May 17, 2012

(54) Method And Apparatus Of Free-Space Optical Signal Reception Having Enhanced Performance In Scattering Environments

(76) Inventor: Thomas H. Wood, Holmdel, NJ (US)

(21) Appl. No.: 12/945,342

(22) Filed: Nov. 12, 2010

(51) Int. Cl. H04B 10/00

(52) U.S. Cl. 398/118

(57) ABSTRACT

A free space optical receiver is provided that can mitigate the detrimental effects of scattering. In an implementation, the optical beam is imaged onto a detector array in the image plane of the receiver telescope. The detector array has a series of two or more concentric zones for detecting optical power, i.e., for converting optical input to electrical output. The electrical output from each of the detection zones is processed by a respective adaptive equalizer, which is operative for compressing the detected signal pulses to counteract the effect of delay spread and thereby to reduce inter-symbol interference. The outputs from the respective adaptive equalizers are then combined for the purpose of signal recovery.

### FIELD OF THE INVENTION

This invention relates to methods and apparatus of free-space optical communication.

### ART BACKGROUND

Free-space optical communication (FSO) has been considered with favor for applications such as building-to-building, vehicle-to-building, vehicle-to-aircraft, and aircraft-to-aircraft communication links, because of certain known advantages over conventional radiofrequency links. These advantages include higher bandwidth, reduced size, weight, and power, and freedom from limitations to allocated spectrum.

However, FSO links suffer from the disadvantage that they are susceptible to disruption under conditions of severe optical scattering due to atmospheric aerosols. Aerosols that are of concern in this regard include fog, mist, dust, clouds, and smoke, and may be of natural or artificial origin.

One of the effects of atmospheric aerosols is to attenuate the optical beam from the FSO transmitter. However, the detrimental effect that aerosols have on FSO is due primarily to scattering. A typical FSO receiver includes a telescope focused on the source and having one or more optical detectors situated in its image plane. Scattering causes the transmitter beam to spread in space, leading to formation of a diffuse, extended image of the source in the image plane of the telescope. As a consequence, less optical power per unit area impinges on the optical detectors, and the optical signal is received with a reduced signal-to-noise ratio.

A second detrimental effect of scattering is time-delay spread, i.e., dispersion, of the optical signal. That is, the multi-path nature of scattering leads to a spread in the path lengths taken by individual rays of light from the source to the receiver. Those rays that traverse longer paths experience more delay than those that traverse shorter paths. In digital communication over an optical link, the signals are transmitted as sequences of pulses. In severe scattering environments, the delay spread may be comparable to the spacing between successive pulses. In such a case, pulses may overlap, leading to inter-symbol interference (ISI), which can reduce the achievable data transmission rate and impede signal recovery.

The spreading of the optical signal in space and in time due to scattering can limit the conditions under which FSO communication systems are advantageously deployed.

### SUMMARY OF THE INVENTION

I have developed a new approach for use at the receiver for mitigating the detrimental effects of scattering. Briefly, my approach increases the amount of usable, received light by collecting scattered light over a larger field of view, or equivalently, a larger range of angles-of-arrival, than is typical for conventional FSO systems. In implementations of my approach, the received light is segregated according to angle-of-arrival, and electronic equalizers are used for recovering the data.

More specifically, the optical beam is imaged onto a detector array in the image plane of the receiver telescope. The detector array has a series of two or more concentric zones for detecting optical power, i.e., for converting optical input to electrical output. The electrical output from each of the detection zones is processed by a respective adaptive equalizer, which is operative for compressing the detected signal pulses to counteract the effect of delay spread and thereby to reduce ISI. The outputs from the respective adaptive equalizers are then combined for the purpose of signal recovery.

Accordingly, one embodiment includes a focusing optical system having an image plane, a photodetection system, and two or more adaptive equalizers. The photodetection system includes two or more photodetectors that are operative to convert impinging electromagnetic radiation to electrical outputs. The photodetectors are arranged with respect to two or more concentric detection zones of the image plane such that, in operation, radiation impinging each detection zone produces a respective electrical output. The adaptive equalizers are electrically connected to the photodetectors. They are operative to compress electrical pulses received from the photodetectors and to produce as output a compressed pulse corresponding to each of the detection zones. A processor, which may e.g. be a diversity detector, is electrically connected to the adaptive equalizer. The processor is operative to correlate compressed pulses across the respective detection zones and to communicate the result of the correlation.

### BRIEF DESCRIPTION OF THE DRAWING

FIG. 1a is a schematic drawing illustrating optical scattering of a beam from a transmitter to a receiver of a FSO communication system. FIGS. 1b and 1c are illustrative profiles of scattered beams in the detector plane, due to low scattering and high scattering environments, respectively.

FIGS. 2a and 2b are graphs resulting from a computational simulation based on a model of optical scattering. FIG. 2a is a histogram of optical detection events versus radial location in the receiver image plane. FIG. 2b is a series of histograms of optical pulse arrivals versus arrival time, showing how delay spread increases with radial position.

FIG. 3 is a schematic drawing of a FSO receiver according to one embodiment. In the figure, the image plane of the receiver telescope is shown in two views: A side view to facilitate an understanding of the range of angles-of-arrival of the received beam, and an axial view to facilitate an understanding of the concentric arrangement of detection zones.

### DETAILED DESCRIPTION

Our approach is well-suited for use with optical beams having a wavelength of 1.5 micrometers, which is a wavelength widely used in optical communications. However, our approach is not limited to wavelengths at or near 1.5 micrometers, but in fact may be used with any infrared, visible, or ultraviolet wavelength for which the optical path from source to detector has sufficient transparency. The embodiment discussed below uses a conventional, direct source-and-receiver system. The disclosed embodiment should be understood as exemplary and not limiting. For example, alternative embodiments may use a modulator-retroreflector based FSO system.

Those skilled in the art will recognize that scintillation is a further atmospheric optical phenomenon that impairs the reception of signals. Scintillation is a refractive effect caused by fluctuations in the density of air in the optical path. Scintillation causes the shape, intensity distribution, and area of the image spot to fluctuate. Our approach may advantageously be used in combination with any of various known techniques for mitigating the effects of scintillation. Additionally, we believe that our approach may itself provide some enhanced tolerance to scintillation, because our detector has a relatively wide field of view, and the processing of multiple signal streams will tend to mitigate the effects of scintillation.

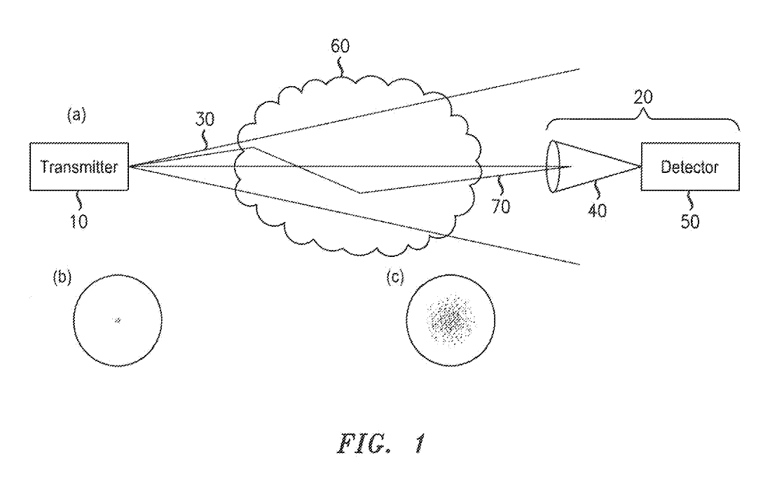

Turning now to FIG. 1a, an FSO link has a transmitter 10 and receiver 20. FSO beam 30 is projected toward receiver 20, where a portion of the beam is collected by receiver telescope 40 and imaged onto detector 50. In the presence of scattering environment 60, illuminance from beam 30 will spread over a broadened range of arrival angles at the entrance to telescope 40. This is illustrated in the figure by ray 70, which, after several scattering events, is shown as entering the telescope with a relatively strong deviation from the optical axis, and as being imaged in the detector plane outside of the detector aperture. One consequence of scattering as experienced, e.g., by ray 70 is that light collected by the telescope will be spread over an expanded field of view. This, in turn, can cause a significant fraction of the collected light to miss the detector aperture and fail to be detected.

Those skilled in the art will appreciate that although our illustrative optical system for gathering signal light is a focusing system, other implementations are possible in which a non-focusing collecting optical system is used.

FIG. 1b is a schematic representation of the field of view at the detector when there is little or no scattering. It will be seen that the light is concentrated at the center of the field. A receiver properly designed for non-scattering conditions according to conventional teachings will accept only such centrally concentrated light for detection. By contrast, FIG. 1c schematically represents the same detector field of view when a significant amount of scattering is present. It will be seen that a substantial portion of the collected light falls at some distance from the center of the field, and might therefore fail to be accepted by the detector in a conventional receiver arrangement.

Even if a substantial fraction of the scattered light can be collected and detected, the operation of the FSO communication link may be impaired as a consequence of scattering. That is, due to modulation of the FSO beam, the FSO beam typically takes the form of a sequence of optical pulses, which at high transmission rates may be separated by intervals of one nanosecond or even less. However, scattering (as modeled by geometrical optics) causes the light in the FSO beam to take many paths, many of which have multiple segments, in transit from the transmitter to the receiver. As a consequence, there is a spread in arrival times of the optical pulses. One consequence of this is that consecutive pulses that are sharply defined and distinctly separated when they exit the transmitter, may be broadened in time and may even be overlapping when they enter the receiver. If the spread in arrival times approaches, for example, one nanosecond, it will interfere with the dependable transmission of broadband signals at rates of 1 Gbs and above.

It will be understood that in the following discussion, we use the term “pulse” to refer not only to well-defined optical pulses as they leave transmitter, but also to the same pulses after they have been spread due to atmospheric effects and hence have lost their initial impulsive shapes.

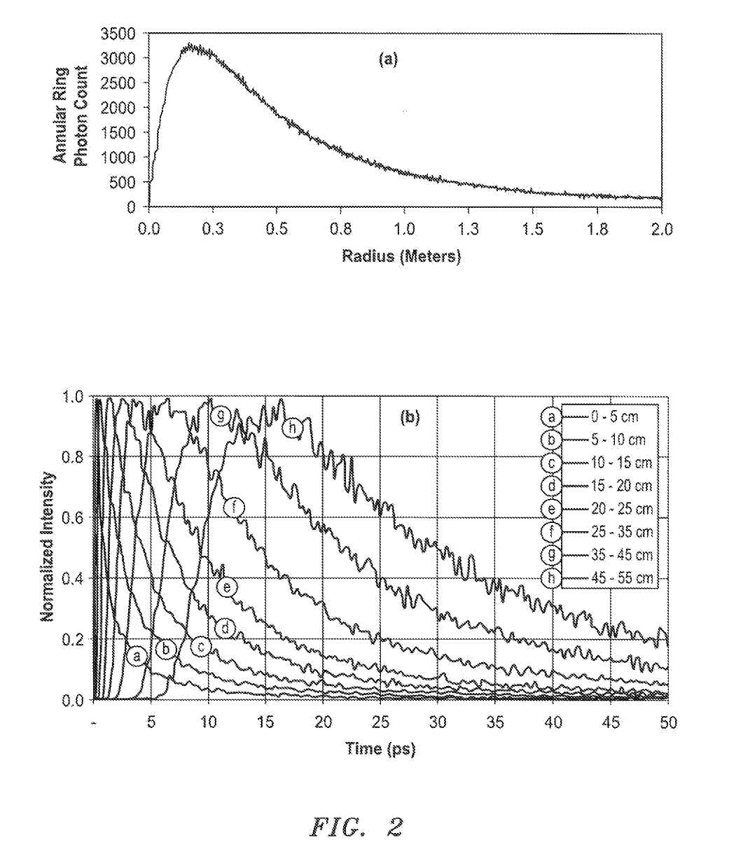

Some appreciation of the spatial and temporal effects of scattering may be gained from FIGS. 2a and 2b, which present the results of a numerical simulation that models pulse propagation over a 100-meter path through heavy advection fog having a mean free path of 17.9 meters between scattering events. It should be noted that we chose to model a relatively short propagation distance through heavy fog purely for convenience, i.e., to simplify the calculation. The solution is expected to scale non-linearly to more typical conditions of lighter fog and propagation distances in the 1-10 kilometer range.

We performed a Monte-Carlo transmission simulation with one million photons, to determine the location and time of arrival of each photon at the telescope aperture plane. FIG. 2a shows a histogram of the arrival locations, showing lateral spreading of the light due to scattering by the aerosol. FIG. 2b shows histograms of pulse arrival times for eight different annular regions, labeled “a” to “h” in the figure. It will be seen that the average delay and the amount of delay spread of the received light are radially dependent in the detector field of view. It will be seen in particular that as the radius increases, the pulses are more delayed and more spread in time.

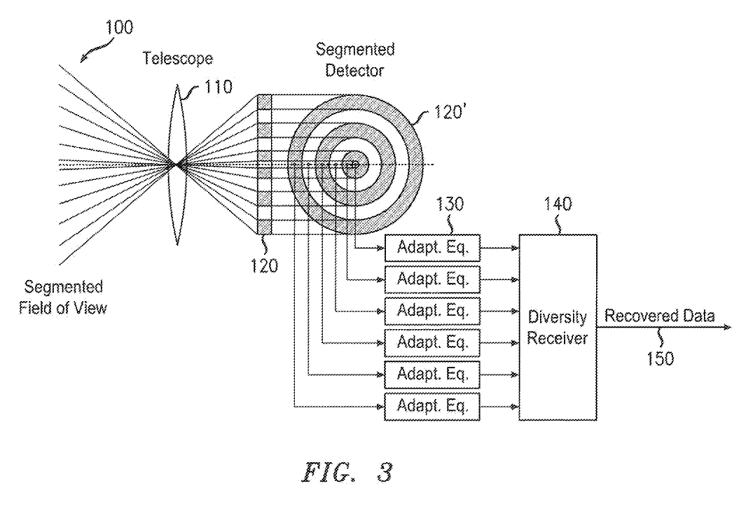

With reference to FIG. 3, we will now describe an FSO receiver that takes into account the dependence on arrival angle that is exhibited by the pulse arrival statistics, in order to provide better reception. Our receiver may work with any conventional FSO transmitter (not shown in the figure), such as a transmitter that sends out return-to-zero, on-off keyed (RZ-OOK) pulses. Numerous other modulation schemes may also be used advantageously, such as pulse-position modulation (PPM) schemes, and thus the invention is not limited to use with any particular modulation schemes.

Turning now to the figure, it will be seen that FSO beam 100 is collected by telescope 110 and projected onto detector 120, 120′, wherein 120 is an elevational view of the detector from the side, and 120′ is an elevational view of the same detector from the end. As best seen in view 120′, the detector is subdivided into a plurality of detection zones, including a central disc-shaped zone and at least one annular zone surrounding and concentric with the central zone. Each zone is effective for converting light that impinges thereon into an electrical output signal, which is directed to a corresponding one of equalizers 130. The outputs of the equalizers, which will be discussed in more detail below, are directed to diversity receiver 140, where they are combined to produce an output stream 150 of recovered data.

The representation of the detector in FIG. 3 is purely conceptual, and should be understood as including any of the various ways that the detector may be realized. For example, the detector may be configured so that an array of photodetectors, e.g. photodiodes or phototransistors, lie in the telescope image plane so that their photoreceptive faces are impinged by the gathered light. In such a configuration, the photodetective elements that compose each detection zone may, for example, be connected in parallel so that a total photocurrent representing the total optical energy impinging that zone may be collected.

It should be noted that although a concentric arrangement of detection zones is described here, other arrangements are also possible, for example rectangular or hexagonal tilings of detection zones. It should also be noted that although it is generally advantageous to process the outputs of all of the photodiodes in equalizers, it is also possible to perform the next stage of processing directly on some of the photodetector outputs without first subjecting them to an equalizer. Accordingly, some implementations may pass the output of one or more, but not all, detection zones through an equalizer.

Techniques for manufacturing photodiode arrays are well known, and include, for example, fabrication techniques in silicon or other semiconductor materials for forming arrays integrated on a single wafer, as well as techniques for assembling an array by bonding individual diode elements on a printed circuit board or other substrate.

In other implementations, optical methods are employed to gather the light impinging on a particular detection zone, and to direct the gathered light to a photodetector. For example, the end faces of a plurality of optical fibers may be arrayed in each detection zone. Downstream of the impinging light, the fibers corresponding to each detection zone may be fused and tapered to form an output fiber that directs the collected light to a photodetector.

In still other implementations, processing of the collected optical signal including at least equalization is performed in the optical domain. In such implementations, the respective detection zones are replaced by optical collection zones, which forward their respective portions of the collected light for equalization in the optical domain, followed by further processing which may also take place in the optical domain.

Returning to our illustrative implementation, the average pulse arrival times and delay spreads characterizing the respective detection zones will vary in a manner similar to the variations among the histograms shown in FIG. 2b. The widths of the respective detection zones may be designed according to various criteria. In one example, they may be designed to capture comparable amounts of light in anticipated average, or other specified, scattering environments. In one simple arrangement, for example, the central zone has a diameter large enough to capture 90% of the optical energy that impinges the detector plane under ideal atmospheric conditions, and one concentric zone, or preferably two or more concentric zones, each having an active area of the same order of magnitude as the central zone.

Additionally, the telescope may be configured with a variable focal length, so that the scale of the imaged spot of light may be varied relative to the detector array, and in that way adjusted for optimized performance under different scattering conditions.

One advantage of the zoned detection approach described above is due to the fact that in solid state photodetectors, speed tends to vary inversely with area. As a consequence, it will be possible, in general, to make a zoned array of photodetectors that is faster than a single photodetector of comparable total area.

As noted, the electrical output of the detector corresponding to each detection zone is directed to a respective equalizer 130, which is advantageously an adaptive equalizer. The purpose of an equalizer in this regard is to reshape the optical pulses in order to gain better pulse definition and better separation between the pulses. Thus, for example, the equalizers may be manually or adaptively configured to counteract the effects of Raleigh scattering or other atmospheric scattering phenomena.

Those skilled in the art will appreciate that when there is a significant amount of overlap between consecutive pulses, it becomes difficult to interpret the symbol represented by one pulse, due to interference from the other. In the specific case of RZ-OOK modulation, for example, it becomes difficult to determine whether a pulse has, or has not, been sent during a particular symbol interval. This problem is referred to as inter-symbol interference (ISI). Thus, one purpose of the adaptive equalizers is to reduce ISI when the pulses are finally decoded in the diversity receiver 140.

Accordingly, the electrical output from each detection zone is subjected to its own equalizer to recover insofar as possible the original narrow shape of the optical pulses. The respective equalized signals are then combined in the diversity receiver for decoding. As noted, decoding includes, in the case of RZ-OOK modulation, for example, a determination of whether or not a pulse has been received in each symbol interval.

Equalizers useful in this regard are well known and need not be described here in detail. If the equalizer is “adaptive”, a set of weight coefficients is optimized, and is re-optimized from time to time as conditions change, according to some criterion. A typical criterion is minimization of an error rate for the reception of training signals. If ISI is a primary source of error, optimization of the weight coefficients will generally be effective for at least partially restoring the pulse shape and reducing ISI. Thus, for example, to adapt to changing atmospheric conditions, it might be advantageous in at least some cases to send a set of training signals, and re-optimize accordingly, e.g. once per second.

As noted, the decoding decisions are made in diversity receiver 140 using the outputs from the equalizers 130. The term “diversity receiver” should be understood to mean any receiver that operates on two or more input streams to recover a stream of data that is more dependable than would be recovered from any single input stream.

One well-known example of a diversity receiver is a diversity combiner, using, e.g., maximal ratio combining or optimum combining. In both cases, as well as others, a weighted sum of the input streams is formed. The weights are selected in such a way as to suppress interference. In the present context, the interference to be suppressed is that due to ISI.

1. Apparatus comprising:
a collecting optical system;
a spatially discriminatory array configured to receive light collected by the collecting optical system and arranged in two or more detection zones;
one or more equalizers in receiving relationship to respective detection zones, each said equalizer configured to compress signal pulses received from its respective detection zone; and
a processor in receiving relationship to the detection zones such that the pulses received from detection zones having equalizers are received as compressed signal pulses via the respective one or more equalizers;
wherein the processor is operative as a diversity receiver to combine the compressed pulses for recovery of a signal therefrom.

2. The apparatus of claim 1, wherein the collecting optical system is a focusing optical system having an image plane, and the spatially discriminatory array lies in the image plane.

3. The apparatus of claim 1, wherein the collecting optical system is a telescope.

4. The apparatus of claim 1, wherein the collecting optical system is a focusing system having a variable focal length.

5. The apparatus of claim 1, wherein the detection zones include a central zone and at least one annular zone surrounding and concentric with the central zone.

6. The apparatus of claim 1, wherein the equalizer or equalizers are configured to counteract spreading of optical pulses due to Rayleigh scattering.

7. The apparatus of claim 1, wherein the equalizers are adaptive equalizers.

8. The apparatus of claim 1, wherein the spatially discriminatory array comprises two or more photodetectors that are operative to convert impinging electromagnetic radiation to electrical outputs, and each said electrical output corresponds to a respective one of the detection zones.

9. The apparatus of claim 1, wherein:
the spatially discriminatory array comprises two or more photodetectors that are operative to convert impinging electromagnetic radiation to electrical outputs;
each said electrical output corresponds to a respective one of the detection zones;
each said equalizer is electrically connected to one or more photodetectors belonging to a respective detection zone;
each said equalizer is operative to compress electrical pulses received from its respective one or more photodetectors; and
the processor is electrically connected to the photodetectors such that each photodetector that has an equalizer connects to the processor through the pertinent equalizer.

10. The apparatus of claim 1, wherein the processor is operative to determine the values of data symbols as a result of correlating the compressed pulses, and to communicate the determined values of the data symbols.

11. Apparatus comprising:
a focusing optical system having an image plane;
a photodetection system comprising two or more photodetectors that are operative to convert impinging electromagnetic radiation to electrical outputs, said system being arranged with respect to two or more concentric detection zones of the image plane such that, in operation, radiation impinging each detection zone produces a respective electrical output;
an adaptive equalizer electrically connected to each of the photodetectors and operative to compress electrical pulses received from the photodetectors and to produce in response to an input optical pulse sequence an output sequence of compressed pulses corresponding to each of the detection zones; and
a processor electrically connected to the adaptive equalizer in receiving relationship to each of the output sequences of compressed pulses and operative as a diversity receiver to combine the compressed pulses for recovery of a signal therefrom.

12. The apparatus of claim 11, wherein the photodetection system comprises a concentric arrangement of solid state photodetectors having a common face situated substantially in the image plane.

13. A method, comprising:
directing each of a plurality of incoming optical pulses onto a spatially discriminatory array organized into two or more detection zones;
in response to each of the incoming optical pulses, producing an output pulse from each detection zone;
compressing the output pulses from one or more of the detection zones; and
combining the output pulses from the respective detection zones, thereby to produce an output value corresponding to each of the incoming optical pulses.

14. The method of claim 13, wherein the directing step comprises focusing the incoming optical pulses onto a detection plane organized into detection zones.

15. The method of claim 13, wherein the detection zones are concentric.

16. The method of claim 13, further comprising converting each incoming optical pulse to an electrical pulse such that the optical pulse portion falling on each detection zone engenders a respective electrical pulse; and wherein the compressing and combining steps are performed on the electrical pulses.

17. The method of claim 13, wherein the compressing step is carried out so as to counteract the spreading effect of Rayleigh scattering.

18. The method of claim 13, wherein the combining step comprises correlating the output pulses from the respective detection zones, thereby to produce decisions whether a pulse is present or absent in a given symbol intervals.

19. The method of claim 13, wherein the compressing step is carried out by adaptive equalization, and the correlating step is carried out by diversity reception.

20. The method of claim 13, wherein the compressing step is carried out by an adaptive equalizer, and the method further comprises adapting a vector of parameters of the adaptive equalizer to minimize intersymbol interference between adjacent optical pulses.
